(19) United States
(12) Patent Application Publication
(10) Pub. No.: US 2016/0276825 A1
(43) Pub. Date: Sep. 22, 2016

(54) FAULT CONTROL SYSTEM IN MACHINE

(71) Applicant: Caterpillar Global Mining LLC, South Milwaukee, WI (US)

(72) Inventor: Omar J. Abdel-baqi, Oak Creek, WI (US)

(73) Assignee: Caterpillar Global Mining LLC, South Milwaukee, WI (US)

(21) Appl. No.: 15/168,454

(22) Filed: May 31, 2016

(51) Int. Cl. H02H 7/06; H02P 9/00; H02K 3/28; H02H 3/16

(52) U.S. Cl. CPC H02H 7/06; H02H 3/165; H02P 9/006; H02K 3/28

(57) ABSTRACT

A fault control system in a machine is provided. The machine may include a double wound AC alternator that includes a first neutral and a second neutral. The fault control system includes a phase fault control circuit connected across the first neutral and the second neutral of the double wound AC alternator. The phase fault control circuit is adapted to generate a control signal for a control system upon detecting a voltage difference between the first neutral and the second neutral. The fault control system includes a voltage divider circuit having a pair of current limiting resistors is connected parallel across the first neutral and the second neutral. The fault control system also includes a ground fault detection circuit to detect a ground fault. The voltage divider circuit precludes the ground current flowing to the phase fault control circuit when a voltage difference between the current limiting resistors is zero.

### TECHNICAL FIELD

The present disclosure relates to fault control systems of electrical devices and more particularly to a fault control system for electrical devices in machines.

### BACKGROUND

Machines, such as shovels and excavators, include a variety of electrical devices, such as alternators and electric motors. These electrical devices can be vulnerable to different types of faults including ground faults, phase to neutral faults, and phase to phase faults, The fault of the electrical devices leads to short circuit conditions, in which current leaks through various components of the machine connected to the electrical devices. When there is a leakage of significant amount of current, the electrical devices of the machine may get damaged which may lead to a subsequent failure of the electrical devices. In order to determine such leakage of current, fault detection circuits, such as ground fault detection circuit, or phase fault detection circuit are provided. The ground fault detection circuit detects a ground fault in the electrical devices but fails to identify the phase fault. On the other hand, the phase fault detection circuit is designed to detect a phase fault, but fails to identify the ground fault.

U.S. Pat. No. 5,587,864, hereinafter referred to as the '864 patent, relates to a three-phase electrical system that includes an interrupt controller. The interrupt controller protects against inadvertent current flow between a phase conductor and ground and between phase conductors. The interrupt controller measures the voltage across a series connection of current transformers disposed about various phase conductors. If an inadvertent current path exists between one of the phase conductors and ground or between two of the phase conductors, the interrupt controller interrupts the current flow in the phase conductors. The '864 patent provides a single-phase electrical system with a hot conductor and a neutral conductor and includes an interrupt controller. The interrupt controller protects against inadvertent current flow between the hot conductor and ground and between the hot conductor and the neutral conductor.

The interrupt controller measures the voltage across a series connection of current transformers disposed about the hot and neutral conductors. If an inadvertent current path exists between the hot conductors and ground or between the hot conductor and the neutral conductor, the interrupt controller interrupts the current flow in the hot and neutral conductors.

### SUMMARY OF THE DISCLOSURE

In one aspect of the present disclosure, a fault control system for a double wound AC alternator is provided. The double wound AC alternator includes a first neutral and a second neutral. The fault control system includes a phase fault control circuit connected across the first neutral and the second neutral of the double wound AC alternator. The phase fault control circuit is adapted to generate a control signal for a control system upon detecting a voltage difference between the first neutral and the second neutral of the double wound AC alternator. Further, the fault control system includes a voltage divider circuit having a pair of current limiting resistors, the pair of current limiting resistors. The current limiting resistors are connected in parallel across the first neutral and the second neutral of the double wound AC alternator. The fault control system also includes a ground fault detection circuit. The ground fault detection circuit is adapted to detect a ground fault by establishing a closed path for a ground current flowing from a current carrying conductor of an electrical device to one of the first neutral and the second neutral of the double wound AC alternator through the voltage divider circuit. The voltage divider circuit precludes the ground current flowing to the phase fault control circuit when a voltage difference between the current limiting resistors of the voltage divider circuit is zero.

Other features and aspects of this disclosure will be apparent from the following description and the accompanying drawings.

### BRIEF DESCRIPTION OF THE DRAWINGS

FIG. 1 is a schematic view of a machine including at least one alternator and an electrical device, according to an embodiment of present disclosure;

FIG. 2 is a circuit diagram illustrating a phase fault control circuit connected to the alternator of FIG. 1;

FIG. 3 is a circuit diagram illustrating a ground fault detection circuit connected to the alternator of FIG. 1; and

FIG. 4 is a circuit diagram illustrating the fault control system including. the ground fault detection circuit and the phase fault control circuit, connected to the electrical device of FIG. 1 using a voltage divider circuit.

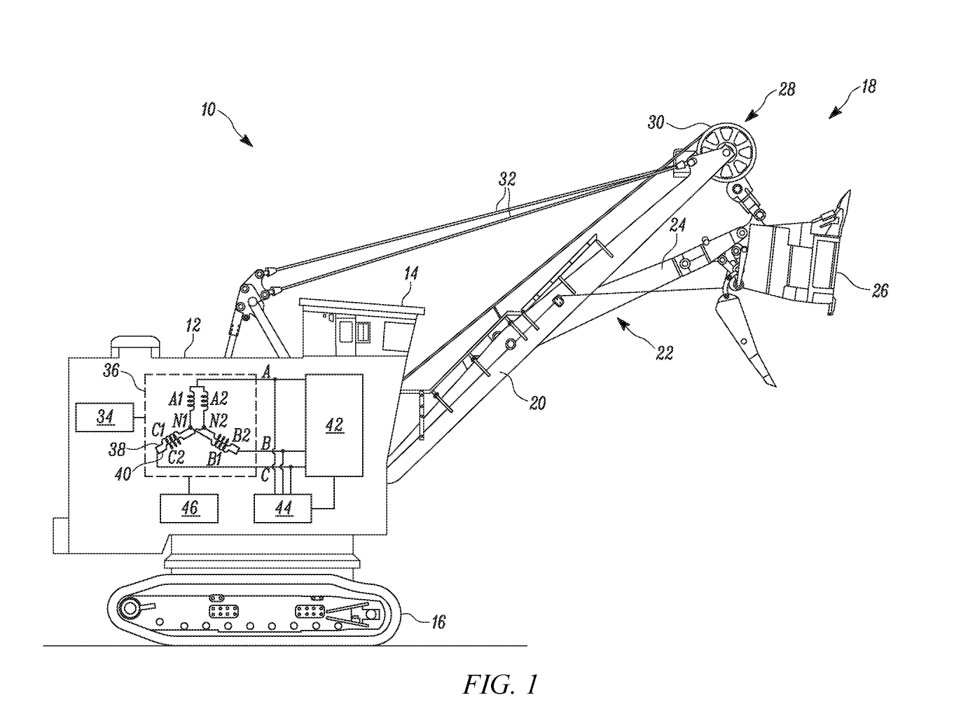

### DETAILED DESCRIPTION

Wherever possible, the same reference numbers will be used throughout the drawings to refer to the same or the like parts, FIG. 1 is a schematic view of a machine 10 according to an embodiment of the present disclosure. In an example, the machine 10 may embody a shovel, such as a rope shovel. Alternatively, the machine 10 may be a hydraulic shovel or a dragline excavator. It should be understood that the machine 10 may embody any wheeled or tracked machine associated with mining, agriculture, forestry, construction, and other industrial applications, without any limitations.

The machine 10 includes a frame 12 and an operator cabin 14 mounted on the frame 12. The operator cabin 14 may provide an operator interface (not shown), which may include one or more input devices (not shown), such as an accelerator, braking pedals, a steering, a joystick, knobs, levers, switches, and display devices. The input devices may operate and control one or more parameters of the machine 10. The operator interface also includes one or more output devices (not shown), such as a display screen, a warning light, an emergency shut-down button, and a haptic feedback arrangement.

The machine 10 includes ground engaging members 16, such as tracks coupled to the frame 12. In another example, the ground engaging members 16 may include a set of one or more wheels, a set of one or more rollers or any other type of the ground engaging members 16 known in the art. In an embodiment, the ground engaging members 16 propel the machine 10 forward or backward on ground.

The machine 10 further includes an implement system 18. The implement system 18 of the machine 10 is coupled to the frame 12. The implement system 18 can he used for various applications, such as loading material. The implement system 18 may vary based on particular type of the machine 10 and the application of the machine 10. In an embodiment, the implement system 18 includes a boom 20 extending from and coupled to the frame 12. The implement system 18 also includes a crowd mechanism 22 extending from the boom 20. The crowd mechanism 22 includes a handle 24 and a dipper 26 coupled to the handle 24. The crowd mechanism 22 extends or retracts the dipper 26 based on a sliding movement of the handle 24. It should be noted by one skilled in the art that movement may he provided to the crowd mechanism 22 by any known arrangement including, but not limited to, pneumatic arrangement, hydraulic arrangement and/or cable arrangement. The implement system 18 includes a hoist mechanism 28 provided on the boom 20. The hoist mechanism 28 also includes a winch (not shown), a pulley 30 and hoist cables 32. The hoist mechanism 28 raises or lowers the dipper 26.

The ground engaging members 16 and the implement system 18 receive power from a power source 34. The power source 34 may also supply power to various other components of the machine 10 including, but are not limited to, a transmission system (not shown), drive shafts (not shown), and an alternator 36. The power source 34 may be an internal combustion engine, for example, a diesel engine, a gasoline engine, a gaseous fuel engine, or any other type of combustion engine known in the art. The power source 34 may be mounted on the frame 12 of the machine 10.

In an embodiment, the power source 34 is mechanically coupled to the alternator 36. It may be noted that the power source 34 may be coupled to one or more alternators. The alternator 36 may be at least a single phase alternator and/or a poly phase alternator producing Alternating Current (AC). In an embodiment, the alternator 36 is a double wound AC alternator. The alternator 36 includes three phase lines A, B, and C having two sets of windings. The two sets of windings include a first set of windings 38 and a second set of windings 40. The first set of windings 38 includes windings A1, B1, and C1 for the three phase lines A, B and C. The first set of windings 38 is connected to a first neutral N1. The second set of windings 40 includes windings A2, B2, and C2. The second set of windings 40 is connected to a second neutral N2. The first set of windings 38 and the second set of windings 40 are magnetically coupled and electrically isolated. from each other.

The power source 34 drives the alternator 36 to generate electrical energy. The alternator 36 is connected to an electrical device 42 of the machine 10 for driving the electrical device 42. In an embodiment, the electrical device 42 connected to the alternator 36 is a DC motor. The DC motor is connected to the alternator 36 via a rectifier (not shown). The rectifier converts AC generated by the alternator 36 to direct current (DC). It may be contemplated that the machine 10 may include multiple electrical devices 42 that are connected to the alternator 36. In an example, the alternator 36 is connected to a battery 44. The battery 44 is charged using the electrical energy generated by the alternator 36. The battery 44 may be connected to the electrical device 42 to provide electrical energy to the electrical device 42.

The alternator 36 is electrically connected to the electrical device 42 and/or the battery 44 of the machine 10, via the phase lines A, B, and C. In other embodiments, the alternator 36 may be connected to an AC motor, a synchronous motor, an induction motor, a single phase motor, a three phase motor, or any other type of suitable motor known in the art. In the preferred embodiment, the alternator 36 is electrically connected to the battery 44 and/or the electrical device 42 via multiple current carrying conductors.

In an example, the electrical device 42 may be used for operating the implement system 18 of the machine 10. The electrical device 42 may be connected to the hoist cables 32 to control the movement of the implement system 18.

The machine 10 further includes a fault control system 46 electrically connected to the first and second neutrals N1, N2 of the alternator 36. The fault control system 46 detects and controls fault current associated with the alternator 36 and/or the electrical device 42 connected to the alternator 36. In one example, the fault control system 46 is also enabled to detect and control the fault current associated with the electrical device 42 when the electrical device 42 draws power from the battery 44.

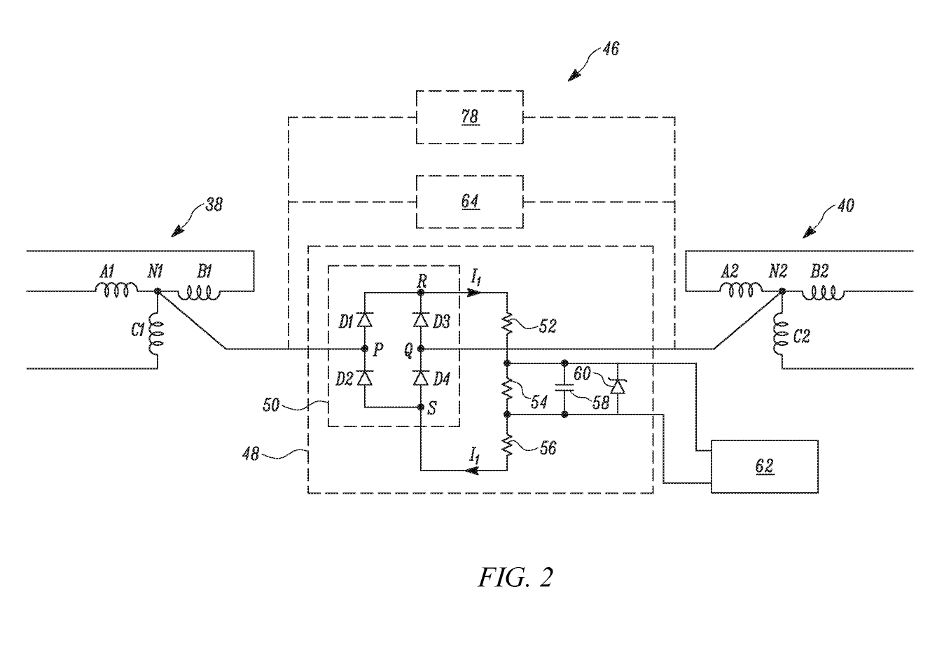

Referring to FIG. 2, the fault control system 46 includes a phase fault control circuit 48 for detecting a phase fault of the electrical device 42 and/or the alternator 36. The phase fault leads to a short circuit condition thereby generating a large current leaking through various components of the machine 10 that are electrically connected. The phase fault control circuit 48 detects and controls the phase fault associated with the alternator 36 and/or the electrical device 42 connected to the alternator 36.

The phase fault includes a phase to phase fault and a phase to neutral fault. The phase to phase fault occurs when a current carrying conductor connected to the electrical device 42 comes in contact with another current carrying conductor. The phase to phase fault occurs when a phase line of the alternator 36 comes in contact with another phase line of the alternator 36. The phase to neutral fault occurs when any one of the multiple current carrying conductors comes in contact with the first neutral N1 and/or the second neutral N2 of the alternator 36. The phase to neutral fault also occurs when the phase line of the alternator 36 comes in contact with the first neutral N1 and/or the second neutral N2 of the alternator 36. The phase fault also includes internal fault of the alternator 36. The internal fault of the alternator 36 may occur when one winding of the alternator 36 conies in contact with another winding of the alternator 36. For instance when the winding A1 of the first set of windings 38 comes in contact with the winding A2 of the second set of windings 40, the internal fault of the alternator 36 may occur.

The phase fault control circuit 48 includes a bridge rectifier 50. The first and second neutrals N1, N2 of the alternator 36 are connected to the bridge rectifier 50. The bridge rectifier 50 includes at least four diodes D1, D2, D3, and D4. The diodes D1, D2, D3, and D4 are connected at each one of the four arms of the bridge rectifier 50, respectively. The diode D1 and the diode D2 are connected to the first neutral N1 of the alternator 36 at a point P. The diode D3 and the diode D4 are connected to the second neutral N2 of the alternator 36 at a point Q. The bridge rectifier 50 is connected in parallel with a set of resistors 52, 54, and 56 at points R and S respectively as shown in the FIG. 2. The phase fault control circuit 48 further includes a capacitor 58 connected in parallel to the resistor 54. The phase fault control circuit 48 also includes a zener diode 60 connected in parallel to the capacitor 58.

During normal operation, the first and second neutrals Ni, N2 carry same amount of current Hence, a voltage difference between the first and second neutrals N1, N2 is approximately zero. Therefore, a voltage difference across the point P and the point Q would also be equal to approximately zero. When phase fault occurs in the machine 10, there is a voltage difference created between the first and second neutrals N1, N2 and this voltage difference between the first and second neutrals N1, N2 induces a corresponding voltage difference between the point P and the point Q. The voltage difference between the points P and Q cause a forward bias in the bridge rectifier 50, The bridge rectifier 50 generates a current I₁. The current I₁ flows through the resistors 52, 54, and 56 connected to the bridge rectifier 50. As the capacitor 58 is connected in parallel to the resistor 54, the capacitor 58 starts charging due to the current I₁. The current I₁ flowing through the resistor 54 increases a voltage across the zener diode 60. The zener diode 60 offers a breakdown beyond a predefined threshold voltage, When the voltage across the zener diode 60 increases beyond the predefined threshold voltage, the zener diode 60 exhibits the breakdown. The breakdown of the zener diode 60 generates a control signal. The control signal is a reverse breakdown current of the zener diode 60. The reverse breakdown current posses equal magnitude and reverse direction of the flow of the current

The zener diode 60 is connected to a control system 62. The control system 62 receives the control signal from the zener diode 60, when the voltage across the zener diode 60 increases beyond the predefined threshold voltage. The control system 62 may initiate a shut down sequence and/or a control action to protect the alternator 36, the electrical device 42 and/or the machine 10 upon the receipt of the control signal. It may be contemplated that values of electrical components, such as the diodes, the resistors, the capacitors, and the zener diode used in the phase fault control circuit 48 may vary based on a voltage generated by the alternator 36 and a specification of the electrical device 42 connected to the alternator 36.

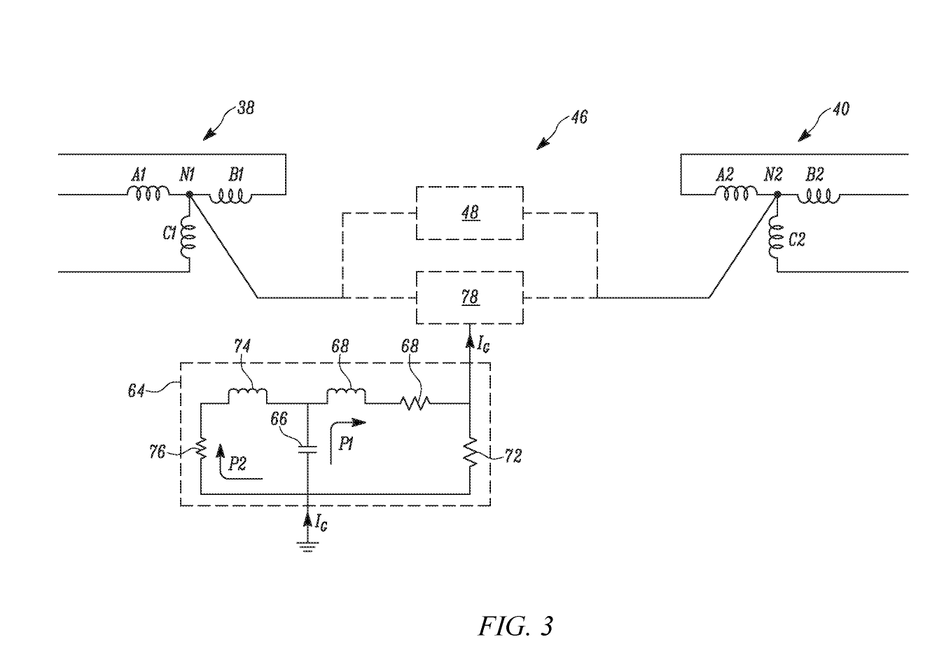

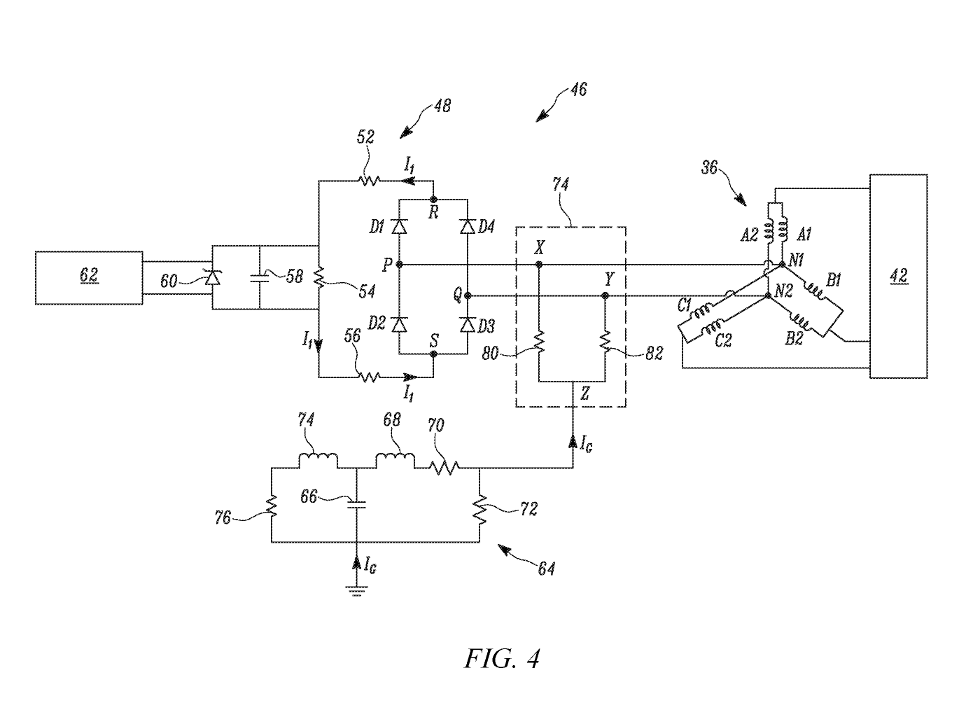

The fault control system 46 includes the phase fault control circuit 48, a ground fault detection circuit 64 and a voltage divider circuit 78. However, for explanatory purpose, the ground fault detection circuit 64 and the voltage divider circuit 78 are illustrated in hidden in FIG. 2, and will be explained hereinafter in detail with reference to FIG. 3 and FIG. 4.

Referring to FIG, 3, the fault control system 46 includes the ground fault detection circuit 64 for detecting a ground fault associated with the alternator 36 anchor the electrical device 42. The ground fault occurs when any phase line of the alternator 36 comes in contact with ground (i.e., for mobile machine applications it is usually the chassis of the machine 10). The ground fault may also occur when any current carrying conductor of the electrical device 42 connected to the alternator 36 comes in contact with ground (i.e., chassis of the machine 10). The ground fault leads to a short circuit condition thereby generating a ground current I_{G}. The ground current I_{G} corresponds to the ground fault occurred in the machine 10. The ground fault detection circuit 64 may measure the ground current I_{G} for detecting the ground fault. In order to measure the ground current I_{G}, the first and second neutrals N1, N2 of the alternator 36 are short circuited and connected to the ground fault detection circuit 64.

In a ground fault condition, the ground fault detection circuit 64 establishes a closed path for the ground current I_{G} from the current carrying conductor of the electrical device 42 (shown in FIG. 1) to the first neutral N1 and/or the second neutral N2. The ground fault detection circuit 64 includes a high frequency path P1 to filter high frequency noise in the ground current I_{G} and a low frequency path P2 to monitor the ground current I_{G}. In order to filter the high frequency noise in the ground current I_{G}, the high frequency path P1 includes a capacitor 66. The high frequency path P1 further includes an inductor 68 and two resistors 70 and 72 connected in parallel to the capacitor 66. The ground current I_{G} enters to the high frequency path P1 via the capacitor 66 connected to ground. Impedance offered by the capacitor 66 decreases with increasing frequency of the ground current I_{G}. The high frequency noise in the ground current flows though the high frequency path P1 and enters in to the first and second neutrals N1, N2 of the alternator 36.

The low frequency path P2 includes an inductor 74 and a resistor 76, that are connected in parallel to the capacitor 66. The capacitor 66 offers high impedance to the ground current I_{G} having low frequency. Hence, the ground current I_{G} flows through the resistor 76. The ground current I_{G} flowing though the resistor 76 is measured via any known apparatus in the art, such as an ammeter. If the ground current I_{G} flowing through the resistor 76 is measured, then the ground fault is notified to an operator using any operator interface present in the operator cabin 14. The ground fault detection circuit 64 offers a high signal to noise ratio for detecting minor ground faults in the machine 10.

FIG. 4 illustrates the circuit diagram of the fault control system 46 including the phase fault control circuit 48 and the ground fault detection circuit 64 connected to the alternator 36 using the voltage divider circuit 78. As mentioned earlier, in order to control the phase fault, the first and second neutrals N1, N2 of the alternator 36 are connected to two arms of the bridge rectifier 50 of the phase fault control circuit 48 (as shown in FIG, 2). In order to detect the ground fault, the first and second neutrals N1, N2 of the alternator 36 are short circuited and connected to the ground fault detection circuit 64 as shown in FIG. 3. The fault control system 46 embodies the voltage divider circuit 78 for connecting the phase fault control circuit 48 and the ground fault detection circuit 64, simultaneously with the alternator 36.

The voltage divider circuit 78 includes a pair of current limiting resistors 80 and 82. In one example, the current limiting resistors 80 and 82 are chosen to limit the fault current to less than one Ampere. The current limiting resistors 80 and 82 are connected in parallel across the first and second neutrals N1, N2 of the alternator 36, at a point X and at a point Y. respectively. The voltage divider circuit 78 is connected in parallel to the phase fault control circuit 48 at the points X and Y respectively. The voltage divider circuit 78 is connected in series with the ground fault detection circuit 64 at a point Z. in normal operation, voltage drops across the current limiting resistors 80 and 82 are approximately equal, since the voltage difference between first and second neutrals N1, N2 of the alternator 36 is approximately zero. It may be contemplated that values of electrical components, such as the diodes, the resistors, the capacitors and the inductors used in the fault control system 46 may vary based on a type of the alternator 36 and a specification of the electrical device 42 connected to the alternator 36.

The phase fault in the machine 10 generates the voltage difference between first and second neutrals N1, N2 of the alternator 36. The voltage difference between the first and second neutrals N1, N2 causes the voltage difference between point P and point Q. the current limiting resistors 80 and 82. The voltage difference between the current limiting resistors 80 and 82 causes the forward bias in the bridge rectifier 50. The bridge rectifier 50 generates the current I₁. The current I₁ flows though the resistors 52, 54 and 56. The current I₁ flows through the resistor 54 charges the capacitor 58. The current I₁ flows through the resistor 54 increases the voltage across the zener diode 60. The zener diode 60 generates the control signal if the voltage across the zener diode 60 increases beyond the predefined threshold voltage.

The ground fault generates the ground current I_{G}. The voltage divider circuit 78 precludes the ground current I_{G} flowing to the phase fault control circuit 48 since the voltage difference between the current limiting resistors 80 and 82 of the voltage divider circuit 78 is approximately zero. For example, in the ground fault condition, the ground current I_{G} equally flows from ground through the ground fault detection circuit 64 to the current limiting resistors 80 and 82. This creates a voltage drop across the current limiting resistors 80 and 82. The voltage drops across the current limiting resistors 80 and 82 are equal as the ground current I_{G} flowing through the current limiting resistors 80 and 82 is approximately equal. Hence, the voltage difference between the current limiting resistors 80 and 82 is approximately zero. In such a scenario, the diodes of the bridge rectifier 50 of the phase fault control circuit 48 are in reverse bias. As a result, the phase fault control circuit 48 offers high impedance to the ground current I_{G} and blocks the flow of the around current I_{G} to the phase fault control circuit 48. Hence, the around current I_{G} flows to the first neutral N1 and/or the second neutral N2 of the alternator 36 via the ground fault detection circuit 64. The ground fault detection circuit 64 detects the ground current I_{G} as explained in the FIG. 3.

### INDUSTRIAL APPLICABILITY

The fault control system 46 described in the present disclosure may be embodied in the machine 10 for detecting and controlling fault of the alternator 36 and/or the electrical device 42 connected to the alternator 36. The fault control system 46 includes the phase fault control circuit 48 and the around fault detection circuit 64 connected to the first and second neutrals N1, N2 of the alternator 36 using the voltage divider circuit 78, The phase fault control circuit 48 detects the phase fault of the alternator 36 and/or the electrical device 42. The ground fault detection circuit 64 detects the ground fault of the alternator 36 and/or the electrical device 42 connected. to the alternator 36. The voltage divider circuit 78 precludes the phase fault control circuit 48 in responding to the ground fault of the machine 10. The fault control system 46 offer a substantially high signal-to-noise ratio (S/N). Therefore, the ground current I_{G} and the current may be detected accurately by the fault control system 46, The fault control system 46 detects and controls the fault in AC carrying conductors and/or DC carrying conductors connected to the alternator 36.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fault control system for a double wound AC alternator including a first neutral and a second neutral, the fault control system comprising:
a phase fault control circuit connected across the first neutral and the second neutral of the double wound AC alternator, the phase fault control circuit adapted to generate a control signal for a control system upon detecting a voltage difference between the first neutral and the second neutral of the double wound AC alternator;
a voltage divider circuit having a pair of current limiting resistors, the pair of current limiting resistors being connected parallel across the first neutral and the second neutral of the double wound AC alternator; and
a ground fault detection circuit adapted to detect a ground fault by establishing a closed path for a ground current flowing from a current carrying conductor of an electrical device to one of the first neutral and the second neutral of the double wound AC alternator through the voltage divider circuit, wherein the voltage divider circuit precludes the ground current flowing to the phase fault control circuit when a voltage difference between the current limiting resistors of the voltage divider circuit is zero.
